(19) United States
(12) Patent Application Publication
(10) Pub. No.: US 2023/0157200 A1
(43) Pub. Date: May 25, 2023

(54) APPARATUS FOR CLOSING A SEED GROOVE

(71) Applicant: ROSEDALE AG SERVICES, LLC, MONTGOMERY, IN (US)

(72) Inventor: MICHAEL WAGLER, MONTGOMERY, IN (US)

(73) Assignee: ROSEDALE AG SERVICES, LLC, MONTGOMERY, IN (US)

(21) Appl. No.: 17/530,757

(22) Filed: Nov. 19, 2021

(51) Int. Cl. A01C 5/06; A01C 7/20

(52) U.S. Cl. CPC A01C 5/068; A01C 7/205; A01C 7/203

(57) ABSTRACT

A furrow closing unit for a planting unit includes a frame adapted to be pivotally coupled with the planting unit, and a pair of coulter blades rotatably attached to the frame and adapted to move soil into a seed groove to facilitate a closing of the seed groove. The furrow closing unit further includes a basket assembly fixedly attached to the frame and having a basket adapted to roll over a soil surface behind the pair of coulter blades. The basket includes a pair of end caps and a plurality of spokes extending between the pair of end caps. The plurality of spokes is arrayed circularly around a central axis of the basket and is arranged spaced apart from each other.

### BACKGROUND OF THE INVENTION

### Field of the Invention

The present invention relates to a device for planting seeds. More specifically, the present invention relates to a device for closing a seed groove after a seed is placed.

### Description of the Related Art

A furrow closing assembly is used in connection with and drawn behind a planter row unit, which is typically towed behind a tractor. The planter row unit opens a furrow in the ground and places seed in the furrow. The closing assembly closes the furrow after placement of the seed. A typical furrow closing assembly, shown in FIG. 1, includes blades 30a and 30b for the purpose of closing the seed groove or furrow after the seed has been placed. A typical closing assembly also includes a press wheel 32 for the purpose of applying pressure to the soil surface after the furrow is closed to improve seed to soil contact. The press wheel 32 moves independently of the blades 30. The independent motion of the press wheel compresses the soil through the application of a consistent force. The independent contact of the press wheel with the ground relative to the closing wheels provides consistent contact between the press wheel and the ground, but results in a rougher ride of the press wheel over the surface and creates a significant amount of chatter when the press wheel passes over the soil.

Accordingly, there is a need for a device that closes a seed groove without compacting the soil unnecessarily thereby improving crop yield. There is also a need for a device that provides for smoother and more consistent contact between the press wheel and the soil surface.

### SUMMARY OF THE INVENTION

It is therefore an object of the present invention to provide a device that closes a seed groove in a way that improves crop yield.

It is also an object of the invention to provide a device that creates a smoother and more efficient ride for the closing unit as it is towed behind the tractor and planting unit.

The present invention meets these objects by providing a rotary basket that leaves the soil looser than a traditional press wheel and by fixing the axle of the rotary basket relative to the axles of the closing wheels resulting in a smoother ride.

According to an aspect a furrow closing unit is provided. The closing unit includes a frame adapted to be pivotally coupled with a planting unit towed behind an agricultural machine, and a pair of coulter blades rotatably attached to the frame and adapted to move soil into a seed groove to facilitate a closing of the seed groove. The closing unit further includes a basket assembly fixedly attached to the frame and having a basket adapted to roll over a soil surface behind the pair of coulter blades. The basket includes a pair of end caps and a plurality of spokes extending between the pair of end caps. The plurality of spokes is arrayed circularly around a central axis of the basket and is arranged spaced apart from each other.

In an embodiment, the frame includes a pair of arms arranged at a first longitudinal end of the frame and adapted to pivotally couple to the planting unit.

According to one embodiment, the basket assembly includes a fork fixedly attached to a second longitudinal end of the frame and extending rearwardly of the frame.

In one embodiment, the fork includes a pair of fork arms coupled to the pair of the end caps of basket assembly.

In an embodiment, the basket is rotatably coupled to the fork arms and is adapted to rotate about the central axis.

According to one embodiment, the closing unit further includes a lever attached to the frame and a spring having one end adapted to be attached to the planting unit and other end attached to the lever, wherein the spring controls a compressive force applied by the basket on the soil.

In one embodiment, the lever is adapted to be displaced between a plurality of positions to vary the compressive force.

According to an embodiment, the frame includes a plurality of detents to keep lever at the plurality of positions.

In one embodiment, the plurality of spokes extends obliquely relative to the end caps.

According to an embodiment, the frame includes a pair of longitudinal sides and a pair of support bars extending downwardly from the pair of longitudinal sides. The pair of coulter blades is rotatably attached to the pair of support bars.

According to an aspect a furrow closing unit is provided. The closing unit includes a frame adapted to be pivotally coupled with a planting unit towed behind an agricultural machine and a pair of coulter blades rotatably attached to the frame and adapted to move soil into a seed groove to facilitate a closing of the seed groove. The closing unit further includes a basket assembly fixedly attached to the frame and having a fork fixedly attached to the frame and extending rearwardly of the frame. The basket assembly also includes a basket rotatably coupled to the fork and adapted to roll over a soil surface behind the pair of coulter blades. The basket includes a pair of end caps and a plurality of spokes extending between the pair of end caps and obliquely to the end caps. The plurality of spokes is arrayed circularly around a central axis of the basket and is arranged spaced apart from each other.

In an embodiment, the frame includes a pair of arms arranged at a first longitudinal ends of the frame and adapted to pivotally couple to the planting unit.

According to an embodiment, the fork includes a pair of fork arms coupled to the pair of the end caps of basket assembly.

In some embodiments, the basket is rotatably coupled to the fork arms and is adapted to rotate about the central axis.

In an embodiment, the closing unit includes a lever attached to the frame and a spring having one end adapted to be attached to the planting unit and other end attached to the lever. The spring controls a compressive force applied by the basket on the soil.

According to an embodiment, the lever is adapted to be displaced between a plurality of positions to vary the compressive force.

In one embodiment, the frame includes a plurality of detents to keep lever at the plurality of positions.

In an embodiment, the frame includes a pair of longitudinal sides and a pair of support bars extending downwardly from the pair of longitudinal sides. The pair of coulter blades is rotatably attached to the pair of support bars.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 illustrates a front perspective view of an existing closing unit as is known in the prior art;

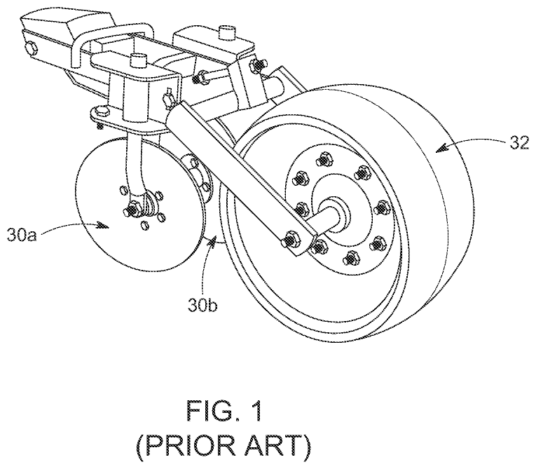

FIG. 2 illustrates a closing unit attached to a planting unit towed behind an agricultural machine, according to an embodiment of the present invention;

FIG. 3 illustrates a side perspective view of the closing unit of FIG. 2, according to an embodiment of the present invention;

FIG. 4 illustrates a top perspective view of the closing unit of FIG. 3, according to an embodiment of the present invention; and

FIG. 5 illustrates a bottom perspective view of the closing unit of FIG. 3, according to an embodiment of the present invention.

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

One presently preferred embodiment of the invention comprises a furrow closing unit having at least one coulter blade to close a seed groove after the seed is deposited inside the seed groove/opening/furrow and a rolling basket trailing the at least one coulter blade to press the soil. The rolling basket facilitates a gentler compression of the soil than the press wheel of the prior art leaving the soil smoother and less compact which promotes growth. Further, the rolling basket is fixedly attached to the frame to which at least one coulter is fixedly attached. Accordingly, the closing unit prevents any independent movement of the rolling basket relative to the at least one coulter blade, enabling a smoother, more consistent ride for the closing unit as a whole.

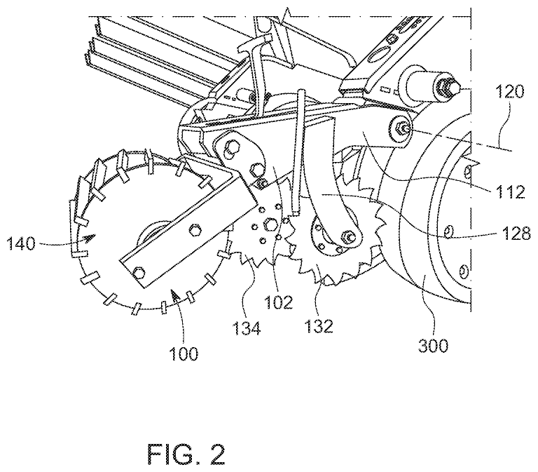

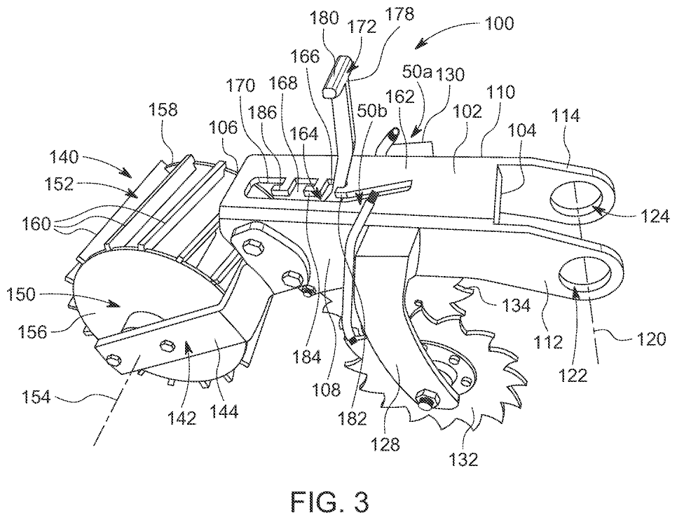

Referring to FIG. 2, a furrow closing unit 100 suitable for closing seed groove/opening/furrow defined in a soil and compacting the soil is shown. The closing unit 100 is adapted to pivotally attach to a planting unit 300 towed behind an agricultural machine, such as, a tractor. Although the tractor is contemplated as the agricultural machine, it may be envisioned that any other agricultural machine suitable for performing operation at an agricultural field can also be utilized. As shown in FIGS. 2 and 3, the closing unit 100 includes a frame 102 having a first end 104 (i.e., a front end 104) and a second end 106 (i.e., a rear end 106) and two longitudinal sides 108, 110 arranged spaced part and extending from the front end 104 to the rear end 106. The frame 102 includes a pair of arms, for example, a first arm 112 and a second arm 114 arranged spaced apart from and substantially parallel to the first arm 112, arranged at the front end 104 of the frame 102. The arms 112, 114 are connected to the planting unit 300 and enables a pivotal coupling of the closing unit 100 relative to the planting unit 300 about a pivot axis 120 that passes through holes 122, 124 of the arms 112, 114 and is aligned with central axes of the holes 122, 124.

Further, the frame 102 further includes at least one support bar, for example a first support bar 128 and a second support bar 130 extending downwardly from longitudinal sides 108, 110 of the frame 102, and is adapted to support at least one coulter blade, for example, a first coulter blade 132 and a second coulter blade 134. As shown, the first support bar 128 is arranged proximate to the arms 112, 114 or the front end 104 of the frame and extends downwardly from a first longitudinal side 108 of the frame 102, while the second support bar 130 extends downwardly from a second longitudinal side 110 of the frame 102 and is disposed proximate to the arms 112, 114 or the front end 104 of the frame 102. Accordingly, the first support bar 128 and the second support bar 130 are disposed spaced apart from each other and are arranged substantially parallel to each other. It may be appreciated that the support bars 128, 130 may be attached to the frame 102 by using fasteners, welding, or any other suitable means known in the art. In some embodiments, the support bars 128, 130 and the arms 112, 114 may be integrally formed or welded with the frame 102. It may be appreciated that the support bars 128, 130 and the arms 112, 114 are fixedly connected to the frame 102 to prevent any relative motion of the arms 112, 114 and support bars 128, 130 relative to the frame 102. The first coulter blade 132 is adapted to rotate relative to the first support bar 128, while the second coulter blade 134 is adapted to rotate relative to the second support bar 130. Further, the coulter blades 132, 134 roll on the surface as the closing unit 100 is linearly displaced. The coulter blades 132, 134 are arranged to laterally displace soil inwardly toward the opposing coulter blades 132, 134 and thereby fill a furrow or opening or seed groove into which seeds have been deposited.

Moreover, the closing unit 100 includes a basket assembly 140 having a fork 142 fixedly attached to the rear end 106 of the frame 102 and extending rearwardly and downwardly from the frame 102. As shown, the fork 142 includes a first fork arm 144 fixedly connected to the first longitudinal side 108 of the frame 102 and a second fork arm 146 fixedly attached to the second longitudinal side 110 of the frame 102. The first fork arm 144 and the second fork arm 146 extend rearwardly and obliquely from the frame 102 and arranged spaced apart from each other and defines a gap 150 therebetween. Also, the basket assembly 140 includes a rolling basket 152 arranged inside the gap 150 and attached to the two fork arms 144, 146. The basket 152 is attached to the fork arms 144, 146 such that the basket 152 is adapted to rotate about its central axis 154 relative to the fork arms 144, 146. Additionally, the basket 152 is a cylindrical structure having two end caps 156, 158 with a first end cap 156 coupled to the first fork arm 144 and a second end cap 158 coupled to the second fork arm 146, and a plurality of spokes 160 extending arrayed circularly around the central axis 154 and extending from the first end cap 156 to the second end cap 158. Also, it may be appreciated that the spokes 160 are arranged such that a gap exist between two consecutive/neighboring/adjacent spokes 160. In some embodiments, the spokes 160 extend obliquely to the end caps 156, 158. Preferably, the spokes 160 are arranged at a 50-degree to 70-degree angle relative to the end caps 156, 158. This helps to ensure proper compaction and finishing of the soil surface while simultaneously preventing clogging of the basket 152 with mud when used in wet conditions. Alternatively, the spokes 160 may be arranged substantially perpendicularly to the end caps 156, 158.

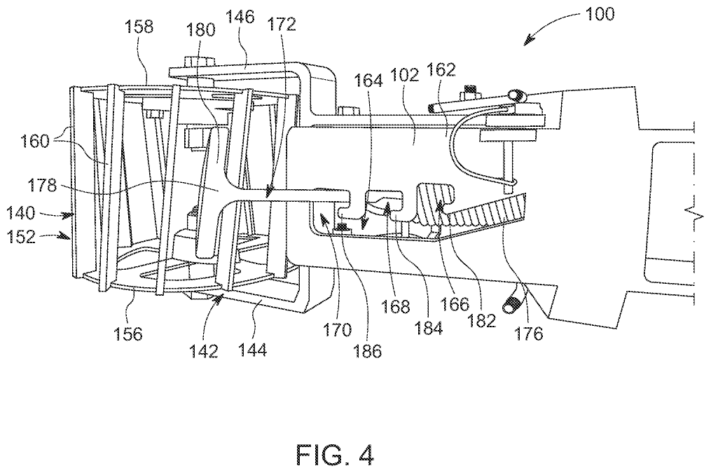

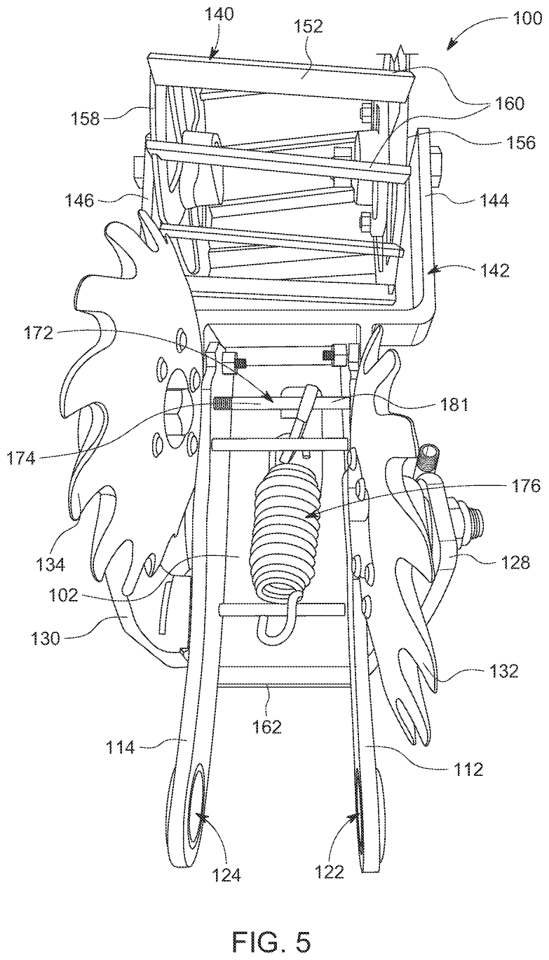

Additionally, or optionally, shown in FIGS. 3 and 4, a top plate 162 of the frame 102 defines an elongated channel 164 and a plurality of cut-outs, for example, a first cut-out 166, a second cut-out 168, and a third cut-out 170 corresponding to a plurality of positions of a lever 172 that enables a control of pressing force applied by the rolling basket 152 on the soil. As shown, the lever 172 includes a first end 174 (shown in FIG. 5) attached to an end of a spring 176 (best shown in FIG. 5) and a second end 178 having a handle 180 to enable a movement of the lever 172 between the plurality of positions. The first end 174 includes a pin 181 which is attached to the frame 102. As shown, the first cut-out 166 is arranged proximate to the front end 104 of the frame 102, the second cut-out 168 is arranged between the first cut-out 166 and the third cut-out 170, and the third cutout 170 is arranged proximate to the rear end 106 of the frame 102. It may be appreciated that the first cut-out 166 corresponds to a first position of the lever 172, the second cut-out 168 corresponds to a second position of the lever 172, and the third cut-out 170 corresponds to a third position of the lever 172. The pressing force applied by the rolling basket 152 on soil increases when the lever 172 is moved from the first position to the third position. The pressing force increases from the first position to the third position due to the pivotal movement of the closing unit 100 in a downward direction towards the soil as the lever 172 is moved from the first position to the third position. The pressing force increases as another end of the spring 176 is attached to the planting unit 300, and the spring 176 gets compressed or stretched as the lever 172 is moved between various positions. Also, the top plate 162 defines a plurality of detents, for example, a first detent 182, a second detent 184, and a third detent 186 to hold the lever 172 at the first position, the second position, and the third position, respectively and prevent the movement of the lever 172 from the first cut-out 166, the second cut-out 168, and the third cut-out 170, respectively.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

What is claimed is:

1. A furrow closing unit for a planting unit, comprising:
a frame adapted to be pivotally coupled with the planting unit;
a pair of coulter blades rotatably attached to the frame and adapted to move soil into a seed groove to facilitate a closing of the seed groove; and
a basket assembly fixedly attached to the frame and having a basket adapted to roll over a soil surface behind the pair of coulter blades, the basket includes a pair of end caps and a plurality of spokes extending between the pair of end caps, the plurality of spokes is arrayed circularly around a central axis of the basket and is arranged spaced apart from each other.

2. The furrow closing unit of claim 1, wherein the frame includes a pair of arms arranged at a first longitudinal end of the frame and adapted to pivotally couple to the planting unit.

3. The furrow closing unit of claim 1, wherein the basket assembly includes a fork fixedly attached to a second longitudinal end of the frame and extending rearwardly of the frame.

4. The furrow closing unit of claim 3, wherein the fork includes a pair of fork arms coupled to the pair of the end caps of basket assembly.

5. The furrow closing unit of claim 4, wherein the basket is rotatably coupled to the fork arms and is adapted to rotate about the central axis.

6. The furrow closing unit of claim 1 further including a lever attached to the frame and a spring having one end adapted to be attached to the planting unit and other end attached to the lever, wherein the spring controls a compressive force applied by the basket on the soil.

7. The furrow closing unit or claim 6, wherein the lever is adapted to be displaced between a plurality of positions to vary the compressive force.

8. The furrow closing unit of claim 7, wherein the frame includes a plurality of detents to keep lever at the plurality of positions.

9. The furrow closing unit of claim 1, wherein the plurality of spokes extends obliquely relative to the end caps.

10. The furrow closing unit of claim 1, wherein the frame includes a pair of longitudinal sides and a pair of support bars extending downwardly from the pair of longitudinal sides, wherein the pair of coulter blades is rotatably attached to the pair of support bars.

11. A furrow closing unit for a planting unit, comprising:
a frame adapted to be pivotally coupled with the planting unit;
a pair of coulter blades rotatably attached to the frame and adapted to move soil into a seed groove to facilitate a closing of the seed groove; and
a basket assembly fixedly attached to the frame and having
a fork fixedly attached to the frame and extending rearwardly of the frame, and
a basket rotatably coupled to the fork and adapted to roll over a soil surface behind the pair of coulter blades, the basket includes a pair of end caps and a plurality of spokes extending between the pair of end caps and obliquely to the end caps, the plurality of spokes is arrayed circularly around a central axis of the basket and is arranged spaced apart from each other.

12. The furrow closing unit of claim 11, wherein the frame includes a pair of arms arranged at a first longitudinal ends of the frame and adapted to pivotally couple to the planting unit.

13. The furrow closing unit of claim 12, wherein the fork includes a pair of fork arms coupled to the pair of the end caps of basket assembly.

14. The furrow closing unit of claim 12, wherein the basket is rotatably coupled to the fork arms and is adapted to rotate about the central axis.

15. The furrow closing unit of claim 11 further including a lever attached to the frame and a spring having one end adapted to be attached to the planting unit and other end attached to the lever, wherein the spring controls a compressive force applied by the basket on the soil.

16. The furrow closing unit or claim 15, wherein the lever is adapted to be displaced between a plurality of positions to vary the compressive force.

17. The furrow closing unit of claim 16, wherein the frame includes a plurality of detents to keep lever at the plurality of positions.

18. The furrow closing unit of claim 11, wherein the frame includes a pair of longitudinal sides and a pair of support bars extending downwardly from the pair of longitudinal sides, wherein the pair of coulter blades is rotatably attached to the pair of support bars.
